(19) United States
(12) Patent Application Publication
(10) Pub. No.: US 2008/0252416 A1
(43) Pub. Date: Oct. 16, 2008

(54) Electronic Device

(75) Inventors: Stefan Posch, Graz (AT); Bruce Duncan, Reading/Berkshire (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,516

(22) PCT Filed: Apr. 27, 2005
(86) PCT No.: PCT/IB2005/051378

§ 371 Date: Oct. 31, 2006

(30) Foreign Application Priority Data
May 4, 2004 (EP) 04252583.2

(51) Int. Cl. H04B 7/00

(52) U.S. Cl. 340/10.1

(57) ABSTRACT

The present invention relates to an electronic device (1) comprising a display (3) and an integrated communication device (4), such as an RFID tag reader. In order to facilitate the positioning of the electronic device (1) in such a way that the communication device (4) is aligned with a corresponding device (6), with which a communication is intended to be carried out, the electronic device (1) is arranged to display a position indication (5), on the display (3), indicating where in the electronic device (1) the communication device (4) is placed.

### FIELD OF THE INVENTION

The present invention relates to an electronic device, comprising a display device for displaying information to a user, and an integrated communication device, for carrying out communication with a complementary communication device, placed within a short distance from the communication device.

### BACKGROUND OF THE INVENTION

Such a device, comprising a portable RFID reader, is disclosed in WO, 01/52179, A2. The RFID reader can be used to collect information from RFID tags. One problem with such a device is that it requires some experience and training to establish a reliable communication easily, without cumbersome trial and error.

### SUMMARY OF THE INVENTION

It is an object of the present invention to provide an electronic device of the above kind which allows for improved communication reliability.

This object is achieved by means of an electronic device according to claim 1.

More specifically, the invention relates to an electronic device, comprising a display device for displaying information to a user, and an integrated communication device, for carrying out communication with a complementary communication device, placed within a short distance from the communication device, wherein the display device is arranged to display a position indication, indicating the position of the integrated communication device in the electronic device. This indication allows the user to align the integrated communication device with the corresponding device, with which communication is intended to be established. This provides a more reliable communication. Moreover, if radio frequency communication is used, less energy need be transmitted, since the operation conditions are optimised. This also reduces the risk of unintentionally established communications with other communication devices nearby.

Preferably the position indication is a graphical indication. This provides information that is easy to interpret and that may be language independent.

In a preferred embodiment the integrated communication device is positioned behind the display device as seen from a user watching the display device, and the graphical indication comprises a graphical symbol positioned on the display device in front of the integrated communication device. This embodiment is particularly well suited for electronic devices with large displays, such as PDAs.

In an alternative embodiment the graphical indication comprises a first and a second line, and the integrated communication device is positioned at the intersection between the extensions of the first and second lines. This allows the provision of a graphical position indication, even if the integrated communication device is not placed behind the display as seen from the user.

In another alternative embodiment, the graphical indication comprises a miniature image of the electronic device, and the image comprises a symbol indicating the position of the integrated communication device in the electronic device. This also allows providing a graphical position indication, even if the integrated communication device is not placed behind the display as seen from the user.

In yet another alternative embodiment the position indication comprises text. This is particularly suitable when the display cannot give an accurate graphical indication.

Preferably, the device comprises input means for activating and/or deactivating the displaying of the position indication.

In a preferred embodiment, the integrated communication device comprises an RFID tag reader.

In an alternative embodiment the integrated communication device comprises an RFID tag.

Alternatively, the integrated communication device may comprise an NFC (Near Field Communication) device.

In another embodiment, the device comprises at least two integrated communication devices, and the display device is arranged to display for each said at least two integrated communication devices, a position indication, indicating the position of the communication device in the electronic device.

In a preferred embodiment, the electronic device is a portable electronic device.

These and other aspects of the invention will be apparent from and elucidated with reference to the embodiments described hereinafter.

### BRIEF DESCRIPTION OF THE DRAWINGS

FIG. 1 illustrates schematically a perspective view of an electronic device according to an embodiment of the invention;

FIG. 2 shows a front view of a device according to an embodiment of the invention;

FIG. 3 illustrates a first alternative embodiment of the invention;

FIG. 4 illustrates a second alternative embodiment of the invention;

FIG. 5 illustrates a third alternative embodiment of the invention; and

FIG. 6 illustrates a fourth alternative embodiment of the invention.

### DESCRIPTION OF PREFERRED EMBODIMENTS

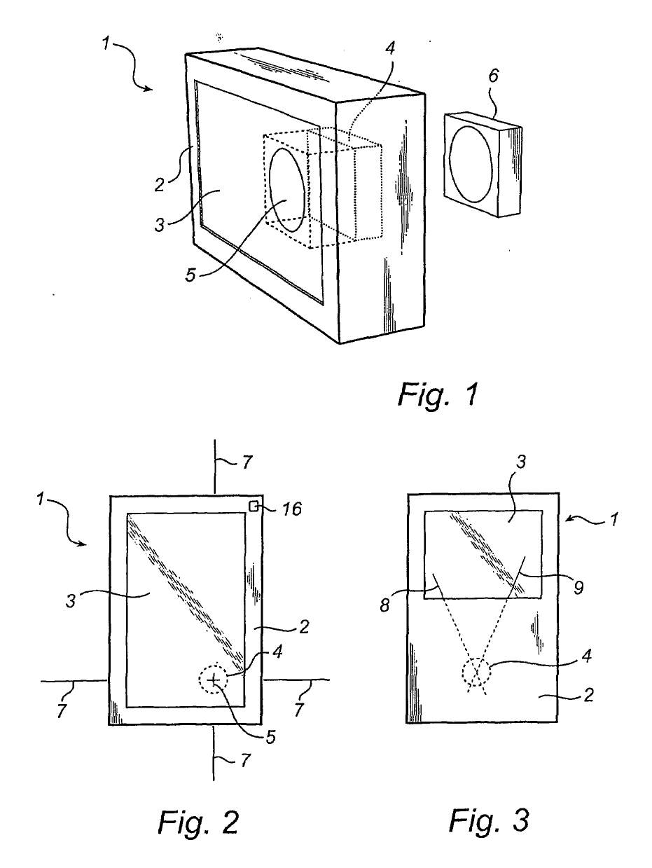

FIG. 1 illustrates schematically a perspective view of an electronic device 1 according to an embodiment of the invention. The device 1 comprises a casing 2 and a display 3, such as e.g. an LCD display, in the casing 2, allowing the displaying of information, i.e. graphics in the form of images and/or text to a user.

The device further comprises an integrated communication device 4, placed in the casing 2. The communication device is intended optionally to be involved in a communication with a complementary device 6, attached to another object nearby, e.g. embedded in a wall. This can be done by keeping the electronic device 1 close to the complementary device. As will be described later, the communication device 4 may consist of any unit in a wide range of units, all having in common that they should be kept at short distance, ranging from e.g. 2-12 centimetres, from the complementary device in order to function in an optimal manner. Thus, the integrated communication device 4 will in general be a short range communication device, e.g. a device suitable for performing a communication a distance shorter than a few, e.g. two, metres.

In a preferred embodiment, the communication device 4 in the electronic device 1 is an RFID tag reader. Such a reader emits an electric field with a predetermined frequency. This field stimulates a complementary device in the form of an RFID tag to emit a response signal comprising tag-specific information. The response signal is picked up by the RFID tag reader.

The RFID tag reader may be kept at some distance from the RFID tag during the reading process, the distance depending e.g. on the RFID tag antenna and the used frequency. It is however advantageous to keep the RFID tag reader close to the RFID tag, since a lower transmitter power may then be used. This entails both a lower energy consumption, which is advantageous e.g. in a battery operated electronic device, and a reduced risk of unintentionally also reading another RFID tag, placed in the proximity of the RFID tag that the user intends to read. Thus, to improve the operation of a communication device, it is important to reduce the distance between the communication device 4 and the complementary device 6 with which it is intended to communicate.

In order to make it easier for the user to hold the communication device 4 close to a complementary communication device, the display device 3 is arranged to display a position indication 5, indicating the position of the communication device 4 in the electronic device 1, i.e. where in the casing 2 the communication device 4 is placed. Such an indication allows the user to accurately align the communication device 4 in the electronic device 1 with the complementary device 6, placed in another object.

The communication device 4 may for example be one of the following; an RFID tag reader (the complementary device being an RFID tag), an RFID tag (the complementary device being an RFID tag reader), an NFC (Near field Communication) device (the complementary device being either another NFC device, an RFID tag, or an RFID tag reader), etc. For NFC devices, reference is made to: Standard ECAM-340, December 2002, “NearField Communication—Interface and Protocol (NFCIP-1)” (ISO/IEC 18092).

A communication is carried out as soon as information is transferred from the communication device 4 belonging to the electronic device 1 to the complementary communication device 6 not belonging to the electronic device 1, or vice versa. Even if the communication device 4 is not embedded in the casing 2, and thus is visible from the outside of the casing 2, the displaying of the position indication 5 may facilitate the alignment of the communication device 4, since the side where the communication device 4 is visible may be concealed by another object when communication is intended to take place.

FIG. 2 shows a front view of a device according to an embodiment of the invention. The electronic device 1 in this embodiment is a flat portable device, comprising a display 3 that is large and covers most of one side of the device 1, e.g. a so called PDA (Personal Digital Assistant). The device 1 comprises a communication device 4, concealed behind the display 3, and is arranged to display a position indication in the form of a graphical indication 5 in front of the communication device 4, e.g. as illustrated: a small cross. This indication 5 allows the user to align the communication device with a corresponding device, e.g. an RFID tag embedded in a wall. There may, as illustrated, be markings 7 on this wall indicating the position of the corresponding device, e.g., as illustrated, in the form of a cross 7.

Preferably, the electronic device 1 comprises input means, e.g. a button 16, for activating and/or deactivating the displaying of the position indication 5. By pressing the button 16, the position indication appears on the display. This input means may be integrated with the display 3 if a pressure sensitive display is used.

FIG. 3 illustrates a first alternative embodiment of the invention. In this case a smaller display 3 is available, compared to the display in FIG. 2, and the communication device 4 is not placed behind the display 3 as seen from a user watching the display 3. In this embodiment therefore a graphical indication is used that comprises a first 8 and a second 9 line. The communication device 4 (concealed by the casing 2) is positioned at the intersection between the extensions of the first and second lines 8, 9.

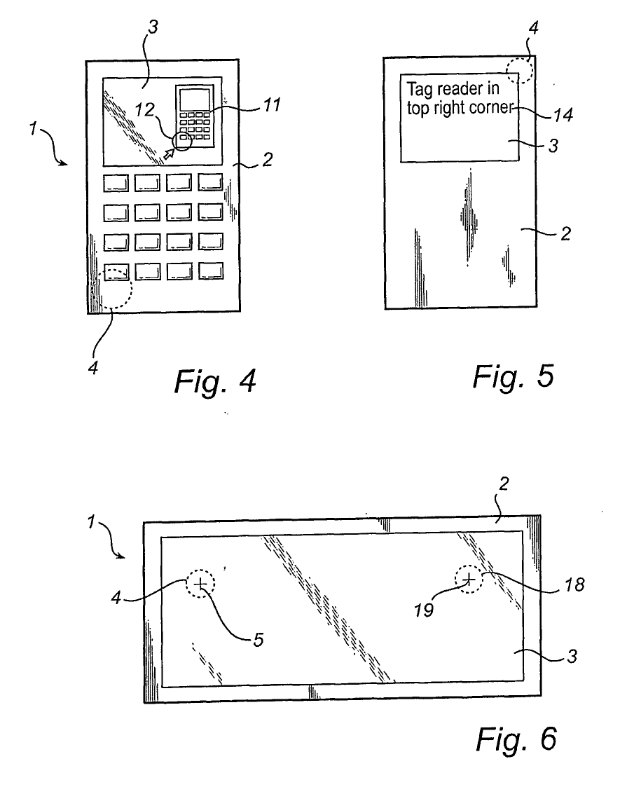

FIG. 4 illustrates a second alternative embodiment of the invention. In this case, the indication comprises a miniature image 11 of the electronic device 1, which image comprises a symbol 12 indicating the position of the communication 4 device in the casing 2. The symbol 12 may be drawn in several ways, e.g. as indicated in the form of a ring, enclosing an area where the communication device 4 is placed, and an arrow pointing at the ring.

FIG. 5 illustrates a third alternative embodiment of the invention. In this case, the position indication comprises text 14: “Tag reader in top right corner”. This embodiment is preferred in cases where the display 3 is such that an accurate graphical position indication cannot be given.

FIG. 6 illustrates a fourth alternative embodiment of the invention. The embodiments illustrated in FIGS. 1-5 relate predominantly to portable applications, such as PDAs, mobile phones, warehouse terminals, etc. However, also corresponding stationary applications are conceivable. FIG. 6 thus illustrates an electronic device 1 in the form of a large, wall mounted, LCD board. The board may be used e.g. for advertising purposes.

In a preferred embodiment, such a device 1 may comprise more than one interface (e.g. antenna) of a communication device 4, 18, the display device 3 may then preferably be arranged to display one position indication 5, 19 for each interface of the communication devices 4, 18, simultaneously or at different occasions. Then a user can perform different operations, such as purchasing different items, by keeping a complementary communication device close to either of the communication devices 4, 18 in the board. Of course, more than two such communication devices 4, 18 may be provided in the board. In an embodiment an array, comprising a large number of communication devices, may be provided.

In summary, the invention relates to an electronic device comprising a display and an integrated communication device, such as an RFID tag reader. In order to facilitate the positioning of the electronic device in such a way that the communication device is aligned with a corresponding device, with which a communication is intended to be carried out, the electronic device is arranged to display a position indication, on the display, indicating where in the electronic device the communication device is placed.

The invention is not restricted to the described embodiment. It can be altered in different ways within the scope of the appended claims.

1. An electronic device (1), comprising a display device (3) for displaying information to a user, and an integrated communication device (4), for carrying out communication with a complementary communication device, placed within a short distance from the integrated communication device (4), wherein the display device (3) is arranged to display a position indication (5; 8, 9; 11, 12; 14), indicating the position of the integrated communication device (4) in the electronic device (1).

2. An electronic device according to claim 1, wherein the position indication is a graphical indication (5; 8, 9; 11, 12).

3. An electronic device according to claim 2, wherein the integrated communication device (4) is positioned behind the display device (3) as seen from a user watching the display device, and wherein the graphical indication comprises a graphical symbol (5) positioned on the display device (3) in front of the integrated communication device (4).

4. An electronic device according to claim 2, wherein the graphical indication comprises a first (8) and a second (9) line and wherein the integrated communication device (4) is positioned at the intersection between the extensions of the first and second lines (8, 9).

5. An electronic device according to claim 2, wherein the graphical indication comprises a miniature image (11; 12) of the electronic device (1), wherein the image comprises a symbol (12) indicating the position of the integrated communication device (4) in the electronic device (1).

6. An electronic device according to claim 1, wherein the position indication comprises text (14).

7. An electronic device according to claim 1, further comprising input means (16) for activating and/or deactivating the displaying of the position indication (5; 8, 9; 11, 12; 14).

8. An electronic device according to claim 1, wherein the integrated communication device (4) comprises an RFID tag reader.

9. An electronic device according to claim 1, wherein the integrated communication device (1) comprises an RFID tag.

10. An electronic device according to claim 1, wherein the integrated communication device (4) comprises an NFC device.

11. An electronic device according to claim 1, comprising at least two integrated communication devices (4, 18), wherein the display device (3) is arranged to display for each said two communication devices (4, 18), a position indication, (5, 19) indicating the position of the communication device (4, 18) in the electronic device.

12. An electronic device according to claim 1, wherein the electronic device is a portable electronic device.
